(19) United States
(12) Patent Application Publication
(10) Pub. No.: US 2015/0142887 A1
(43) Pub. Date: May 21, 2015

(54) DEVICE, METHOD AND MOBILE TERMINAL FOR UPDATING MOBILE SOCIAL NETWORK USER STATE

(71) Applicant: Dingyong Gou, Shenzhen (CN)

(72) Inventor: Dingyong Gou, Shenzhen (CN)

(73) Assignee: ZTE Corporation, Shenzhen (CN)

(21) Appl. No.: 14/402,510

(22) PCT Filed: Jul. 23, 2012
(86) PCT No.: PCT/CN2012/079029

§ 371 Date: Nov. 20, 2014

(30) Foreign Application Priority Data
May 21, 2012 (CN) 201210159885.0

(51) Int. Cl. H04L 12/58

(52) U.S. Cl. CPC H04L 51/32
USPC 709/204

(57) ABSTRACT

A device and method for updating mobile Social Network Service (SNS) user presence status, wherein, a SNS client module in a mobile user terminal sends a registration request to a subscription publishing module to apply for subscribing a profile state change notification; the subscription publishing module records ID of the SNS client module in a notification list for registration, a user switches profiles in a profile interface module; the profile interface module sends an event notification to a background module; the background module reads the content of the new profile entry and notifies the subscription publishing module of the content of the new state; the subscription publishing module queries the notification list and notifies the respective SNS clients one by one of the update; the SNS clients publish the content of the new state in the respective SNS systems.

### TECHNICAL FIELD

The present invention relates to the field of mobile communication, and more particularly, to a device, a method and a mobile terminal for updating mobile social network user presence status.

### BACKGROUND OF THE INVENTION

Social Network Services (SNS) is also known as social networking service. In the narrow sense, the social network refers to a network service such as Facebook, Google+, LinkedIn, Renren, or Pengyou from Tencent inc, which tends to build a strong social relationship with true identity. In the field of Internet, the interpersonal social relationship service is in fact far more than the abovementioned narrow sense social network and can further comprise other forms such as Microblog, Instant Message, and BBS community forum. In fact, these services are penetrated and integrated with each other to push the interpersonal communication channels evolving forward.

Internet-based social communication is currently a very popular business demand, and with the popularity of intelligent terminals such as smart phones and panel computers, more and more attention is paid to the mobile social communication. Users can keep a network connection through a variety of intelligent terminals and even non-intelligent terminals, so as to communicate and share with friends anytime and anywhere. The instant message has states such as “online”, “busy”, “away”, “offline”, and so on, and in communities such as social networks, forums, and microblogs, the networks in some communities now can display the state “online” and “offline” of a friend, and even can chat directly on a web page, but on the whole, the integration of these communication means is still very superficial.

On the other hand, the users at work or in life require mobile terminal devices such as mobile phones do not sound in some cases (for example, in a meeting, in a place such as library), while expect the sound and vibration turned on simultaneously in some other places (when shopping for example), and such settings are called “profiles” on mobile terminals such as mobile phones. The settings of the profiles are related to the state which the user is currently in, such as online, busy, and so on. In fact, the profiles can also be extended as other textual representations, such as personalized signature in the instant message.

The existing SNS is originally developed for desktop computers (including laptops), and lacks or has not enough capability for perceiving the switch of the usage scenario of the users. When the SNS promotes to mobile terminals such as smart phones and forms into the driving force of mobile Internet, there is still a lot of room for improving the user experience of the SNS mobile communication. For example, there is no good solution on the deep integration of the phone's own profiles and the state of the user in the SNS.

### SUMMARY OF THE INVENTION

To solve the technical problem, the embodiment of the present invention provides a device and method for updating SNS mobile user presence status, to make the mobile terminal profile update associated with state update of the mobile network community, so as to enhance the user experience.

The device for updating the mobile SNS user presence status in accordance with an embodiment of the present invention comprises:
a profile interface module, which is configured to: switch profiles of a mobile terminal;
a background module, which is configured to: detect changes of the profile interface module, and when the profile changes, obtain a latest profile setting through a notification from the profile interface module, and notify to a subscription publishing module;
the subscription publishing module, which is configured to: receive requests from SNS client modules for subscribing “profile change notification”, record identifications of the SNS client modules which subscribe the profile change notification, and notify the SNS client modules which subscribe the profile change notification one by one when the profile changes; and
a SNS client module, which is configured to: receive a user presence status update notification published by the subscription publishing module, and publish updated state content in a SNS system.

Alternatively, the subscription publishing module is configured to:
record the identifications of the SNS client modules which subscribe the profile change notification into a notification list for registration, and query the notification list and notify a new profile to respective SNS clients in the notification list one by one when the profile changes.

Alternatively, the SNS comprises: social networks, instant messages, instant messaging communities, microblogs, or forums.

The embodiment of the present invention further provides a mobile terminal, which comprises the abovementioned device for updating the mobile SNS user presence status.

Alternatively, the mobile terminal is a mobile phone or a panel computer.

The embodiment of the present invention further provides a method for updating mobile SNS user presence status, characterized in that, the method is used in a mobile terminal comprising a profile interface module, a background module, a subscription publishing module and a SNS client module, and the method comprises:
the SNS client module sending a registration request to the subscription publishing module to apply for subscribing a profile state change notification;
the subscription publishing module recording an identification of the SNS client module which have subscribed;
when switching the profiles, the background module sending a notification of a profile state change event to the subscription publishing module, and the notification carrying content of a new profile entry;
after receiving the notification of the event, the subscription publishing module notifying the SNS client modules which have subscribed one by one of the content of the new profile entry;
the SNS client modules publishing the content of the new profile entry in a corresponding SNS system.

Alternatively, the subscription publishing module records identifications of the SNS client modules which subscribe the profile change notification into a notification list for registration, and queries the notification list and notifies the new profile to respective the SNS client modules in the notification list one by one when the profile changes.

Alternatively, the SNS comprises: social network, instant message, microblog, or forum.

Alternatively, the mobile terminal is a mobile phone or a panel computer.

With the abovementioned method and device, the user of the mobile terminal does not have to manually update the latest state to each SNS system one by one, but trigger an automatic update via the mobile phone profile, so as to deeply integrate the mobile terminals with the social network services such as, microblogs, instant messages, and so on, thus the user can obtain a better using experience.

### BRIEF DESCRIPTION OF THE DRAWINGS

The accompanying drawings are used to provide a further understanding of the embodiments of the present invention, and constitute a part of the specification but not a limitation of the present invention. In the accompanying drawings:

FIG. 1 is a block diagram of a device in accordance with an embodiment of the present invention;

FIG. 2 is a flow chart of a method in accordance with an embodiment of the present invention.

### PREFERRED EMBODIMENTS OF THE INVENTION

Hereinafter, in conjunction with the accompanying drawings, the preferred embodiments of the present invention will be described. It should be understand that, the preferred embodiments described herein are only used to illustrate and explain but not limit the present invention.

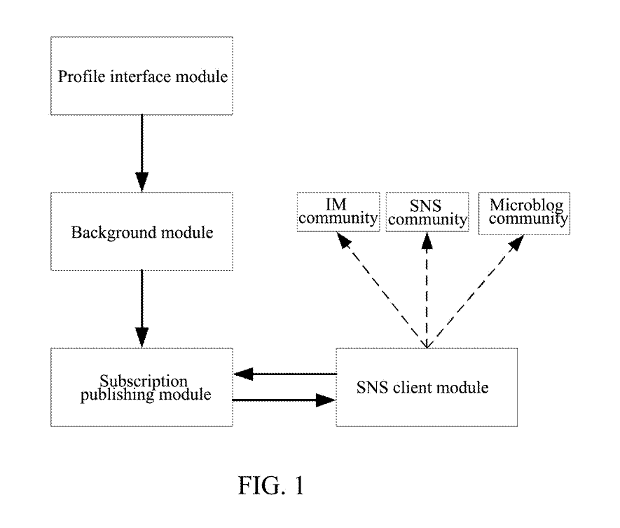

As shown in FIG. 1, the device for updating the mobile SNS user presence status in accordance with the embodiment of the present invention comprises a profile interface module, a background module, a subscription publishing module and SNS client modules. The profile interface module is used to switch the profiles of the mobile terminal, The user can also define the user's own settings including personalized signature besides of the profiles preset in the terminal. The background module is used to detect the changes of the profile interface module, and when the user switches the profiles, the latest profile settings are obtained through the notification of the profile interface module. The subscription publishing module is responsible for receiving the requests of other SNS clients for subscribing the “profile change notification” and recording the identifications of the SNS client modules which subscribe the profile state change notification, and when the profile changes, notifying the respective subscribers one by one according to the registration list. The SNS client modules are used for receiving the user presence status update notification published by the subscriptions publishing module, and publishing the updated state content in the SNS systems.

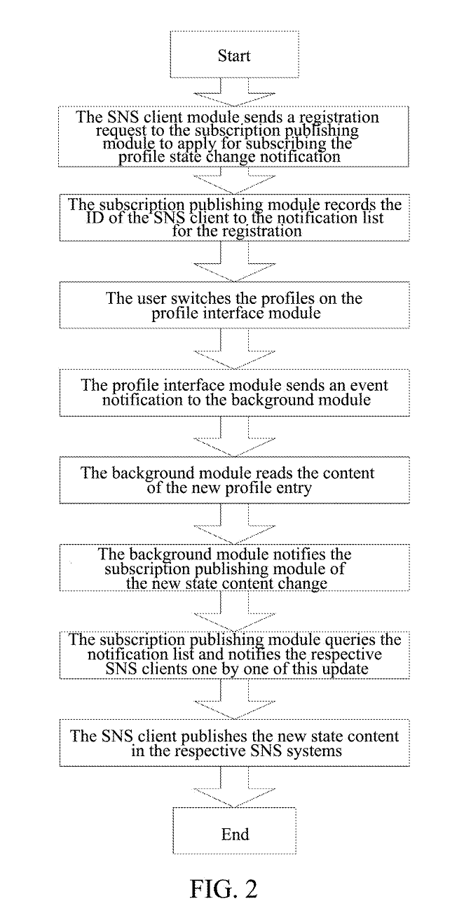

The embodiment of the present invention further relates to a method for updating the SNS mobile user presence status, and refer to FIG. 2, the SNS client module in the mobile user terminal sends a registration request to the subscription publishing module to apply for subscribing the profile state change notification, the subscription publishing module records the ID of the SNS client module into the notification list for registration, the user switches the profiles on the profile interface module, the profile interface module sends an event notification to the background module, the background module reads the content of the new profile entry and notifies the new state content change to the subscription publishing module, the subscription publishing module queries the notification list and notifies this update to the respective SNS clients one by one, and the SNS clients publish the new state content in the respective SNS systems.

The embodiments of the present invention further relates to a mobile terminal, which can be a smart phone or a panel computer, including the device for updating the SNS mobile user presence status. The SNS can be instant messages, instant messaging communities, social networks, SNS communities, microblogs, forums, and so on.

A phone is preset with a normal SNS client module as a SNS client application preloaded in the mobile phone when out of the factory. When the profiles switch, this module is responsible for updating the latest user presence status to each SNS. Since the subscription publishing module provides a public API, the phone does not need to preload the SNS client module. The function of automatically publishing the user presence status update can also be achieved by the user installing the client himself and using a public API.

The embodiment of the present invention can extend the profiles of the mobile terminal, and allow the user to add the user's own customized profile entries, and also support editing the preset common profile entries, including but not limited to, playing sound, phone vibrating, lights flashing, interface icons, customized state text, and other content, the user can add and set different profile entries as needed. For example, the normal mode in the profile may correspond to the user online state in the SNS being the state of “online” or “available”, the user's friends know they can interact with the user in this state, including instant messaging chat, viewing the microblog, commenting on the pictures shared by friends on the SNS. The user can set playing sound when new messages arrive in this state to prompt, and the vibrating alert can also be added for sure; the conference mode may correspond to the user presence status in the SNS being “meeting” or “busy”, and the friends try not to disturb when seeing this state; the phone does not sound when receiving a new message, but a vibrating alert can be sent; the user presence status can be set as “driving on highway” or “invisible” in the SNS for the driving mode, to inform the friends not to disturb right now, the friends can still send a message, but the user's mobile phone does not prompt by sound or vibration when receiving the message, while only displays a prompt of new message on the interface.

Those ordinarily skilled in the art can understand that all or some of steps of the abovementioned method may be completed by the programs instructing the relevant hardware, and the programs may be stored in a computer-readable storage medium, such as read only memory, magnetic or optical disk. Alternatively, all or some of the steps of the abovementioned embodiments may also be implemented by using one or more integrated circuits. Accordingly, each module/unit in the abovementioned embodiments may be realized in a form of hardware, or in a form of software function modules. The present invention is not limited to any specific form of hardware and software combinations.

It should be noted that the present invention may have a variety of other embodiments, and without departing from the spirit and essence of the present invention, one skilled in the art may make various appropriate changes and modifications in accordance with the embodiments of the present invention, and these appropriate changes and modifications should belong to the protection scope of the appended claims of the present invention.

### INDUSTRIAL APPLICABILITY

With the method and device in the present invention, the user of the mobile terminal does not have to manually update the latest state to each SNS system one by one, but trigger an automatic update via the mobile phone profiles, so as to deeply integrate the mobile terminals with social networks services such as microblogs, instant messages, and so on, thus the user can obtain a better using experience.

1. A device for updating mobile social network services (SNS) user presence status, comprising:
a profile interface module, which is configured to: switch profiles of a mobile terminal;
a background module, which is configured to: detect changes of the profile interface module, and when the profile changes, obtain a latest profile setting through a notification from the profile interface module, and notify to a subscription publishing module;
the subscription publishing module, which is configured to: receive requests from SNS client modules for subscribing “profile change notification”, record identifications of the SNS client modules which subscribe the profile change notification, and notify the SNS client modules which subscribe the profile change notification one by one when the profile changes; and
a SNS client module, which is configured to: receive a user presence status update notification published by the subscription publishing module, and publish updated state content in a SNS system.

2. The device of claim 1, wherein, the subscription publishing module is configured to:
record the identifications of the SNS client modules which subscribe the profile change notification into a notification list for registration, and query the notification list and notify a new profile to respective SNS clients in the notification list one by one when the profile changes.

3. The device of claim 1, wherein, the SNS comprises: social networks, instant messages, microblogs, or forums.

4. A mobile terminal, comprising the device for updating mobile SNS user presence status of claim 1.

5. The mobile terminal of claim 4, wherein, the mobile terminal is a mobile phone or a panel computer.

6. A method for updating mobile SNS user presence status, characterized in that, the method is used in a mobile terminal comprising a profile interface module, a background module, a subscription publishing module and a SNS client module, and the method comprises:
the SNS client module sending a registration request to the subscription publishing module to apply for subscribing a profile state change notification;
the subscription publishing module recording an identification of the SNS client module which have subscribed;
when switching the profiles, the background module sending a notification of a profile state change event to the subscription publishing module, and the notification carrying content of a new profile entry;
after receiving the notification of the event, the subscription publishing module notifying the SNS client modules which have subscribed one by one of the content of the new profile entry;
the SNS client modules publishing the content of the new profile entry in a corresponding SNS system.

7. The method of claim 6, wherein,
the subscription publishing module records identifications of the SNS client modules which subscribe the profile change notification into a notification list for registration, and queries the notification list and notifies the new profile to respective the SNS client modules in the notification list one by one when the profile changes.

8. The method of claim 6, wherein,
the SNS comprises: social networks, instant messages, microblogs, or forums.

9. The method of claim 8, wherein,
the mobile terminal is a mobile phone or a panel computer.

10. A mobile terminal, comprising the device for updating mobile SNS user presence status of claim 2.

11. The mobile terminal of claim 10, wherein, the mobile terminal is a mobile phone or a panel computer.

12. A mobile terminal, comprising the device for updating mobile SNS user presence status of claim 3.

13. The mobile terminal of claim 12, wherein, the mobile terminal is a mobile phone or a panel computer.

14. The method of claim 7, wherein,
the SNS comprises: social networks, instant messages, microblogs, or forums.
